(19) United States
(12) Patent Application Publication
(10) Pub. No.: US 2025/0226391 A1
(43) Pub. Date: Jul. 10, 2025

(54) NEGATIVE ELECTRODE MATERIAL FOR LITHIUM ION SECONDARY BATTERY, NEGATIVE ELECTRODE FOR LITHIUM ION SECONDARY BATTERY, AND LITHIUM ION SECONDARY BATTERY

(71) Applicant: TDK Corporation, Tokyo (JP)

(72) Inventors: Shin FUJITA, Tokyo (JP); Takashi MORI, Tokyo (JP)

(73) Assignee: TDK Corporation, Tokyo (JP)

(21) Appl. No.: 19/091,863

(22) Filed: Mar. 27, 2025

Related U.S. Application Data
(63) Continuation of application No. PCT/JP2023/000737, filed on Jan. 13, 2023.

(51) Int. Cl. H01M 4/36; H01M 4/02; H01M 4/38; H01M 4/587; H01M 10/0525

(52) U.S. Cl. CPC H01M 4/364; H01M 4/386; H01M 4/587; H01M 10/0525; H01M 2004/021

(57) ABSTRACT

There is provided a negative electrode material for a lithium ion secondary battery according to a first aspect includes composite particles in which amorphous carbonaceous particles and amorphous silicon particles are complexed. An average primary particle diameter of the silicon particles is 1 nm or more and 50 nm or less. The composite particles include a first composite particle having a silicon content of 0.5% by weight or more and 5% by weight or less, and a second composite particle having a silicon content of 60% by weight or more and 70% by weight or less.

### CROSS-REFERENCE TO RELATED APPLICATION

The present application is a continuation of PCT/JP2023/000737, filed on Jan. 13, 2023, the entire contents of which are incorporated herein by reference.

### TECHNICAL FIELD

The present disclosure relates to a negative electrode material for a lithium ion secondary battery, a negative electrode for a lithium ion secondary battery, and a lithium ion secondary battery.

### BACKGROUND

A lithium ion secondary battery is widely used as a power source for a mobile device such as a mobile phone or a notebook computer, a hybrid car, or the like.

The capacity of the lithium ion secondary battery mainly depends on the active material of the electrode. Graphite may be used as the negative electrode active material. However, there is a demand for a negative electrode active material that provides a higher capacity. Therefore, silicon (Si), which has a much larger theoretical capacity as compared with the theoretical capacity of graphite (372 mAh/g), has attracted attention.

A negative electrode active material containing silicon undergoes a large volume expansion during charging. The volume expansion of the negative electrode active material may cause the deterioration of the cycle characteristics of the battery. In a case where the volume expansion of the negative electrode active material occurs, the decomposition or the like of the electrolytic solution may occur since, for example, the negative electrode active material may be damaged, the conductive path between the negative electrode active material layers may be cut, peeling may occur at the interface between the negative electrode active material layer and the current collector, or cracking may occur in the solid electrolyte interphase (SEI) film. These may deteriorate the cycle characteristics of the battery.

For example, Patent Documents 1 to 3 describe composite particles in which silicon particles and carbonaceous materials are complexed to help improve the cycle characteristics of the battery. Patent documents 1 to 3 describe a mechanochemical method, a mixing and heating method, and the like, as a method in which silicon particles and carbonaceous materials are complexed.

### CITATION LIST

### Patent Document

[Patent Document 1] Japanese Patent No. 4379971
[Patent Document 2] Japanese Patent No. 3995050
[Patent Document 3] Japanese Unexamined Patent Application, First Publication No. 2008-277232

### SUMMARY

The cycle characteristics may be improved in a case where composite particles in which silicon particles and carbonaceous materials are complexed are used. On the other hand, even in a case where composite particles are used, there may be a case where the cycle characteristics are not improved sufficiently or a case where a sufficient discharge capacity cannot be obtained. For example, in a case where complexation is carried out using the mechanochemical method described in Patent Document 1, a part of the silicon compound may be converted into silicon carbide in a case where compressive force and shear force are applied to the carbon material and the silicon compound. Among the silicon compounds, silicon carbide may have a small contribution to charging and discharging, and there may be a case where the negative electrode active material does not exhibit sufficient capacity.

Some embodiments of the present disclosure have been made in consideration of the above issues, and an object of the present disclosure is to provide a lithium ion secondary battery having excellent cycle characteristics.

### Solutions

In order to address the above issues, the following is provided.

(1) A negative electrode material for a lithium ion secondary battery according to a first aspect may include composite particles in which amorphous carbonaceous particles and amorphous silicon particles are complexed. An average primary particle diameter of the silicon particles may be 1 nm or more and 50 nm or less. The composite particles may include a first composite particle having a silicon content of 0.5% by weight or more and 5% by weight or less, and a second composite particle having a silicon content of 60% by weight or more and 70% by weight or less.

(2) In the negative electrode material for a lithium ion secondary battery according to the above-described aspect, a proportion of the first composite particles may be 3% by volume or more and 40% by volume or less, and a proportion of the second composite particle may be 1% by volume or more and 20% by volume or less.

(3) In the negative electrode material for a lithium ion secondary battery according to the above-described aspect, the proportion of the first composite particles may be 6% by volume or more and 30% by volume or less, and the proportion of the second composite particle may be 2% by volume or more and 15% by volume or less.

(4) In the negative electrode material for a lithium ion secondary battery according to the above-described aspect, an average secondary particle diameter of the composite particles may be 3 μm or more and 10 μm or less.

(5) In the negative electrode material for a lithium ion secondary battery according to the above-described aspect, a specific surface area may be 3 m²/g or more and 25 m²/g or less.

(6) A negative electrode for a lithium ion secondary battery according to a first aspect may include the negative electrode material for a lithium ion secondary battery according to the above-described aspect.

(7) A lithium-ion rechargeable battery according to a third aspect may include the negative electrode material for a lithium ion secondary battery according to the above-described aspect, a positive electrode, and an electrolyte connecting the positive electrode and the negative electrode for a lithium ion secondary battery.

### Advantageous Effects

The lithium ion secondary battery according to the above-described aspect may have excellent cycle characteristics.

### BRIEF DESCRIPTION OF DRAWINGS

FIG. 1 is a schematic cross-sectional view of a lithium ion secondary battery according to a first embodiment.

FIG. 2 is an image of a cross section of a negative electrode active material layer according to the first embodiment, which is captured with a scanning electron microscope (SEM).

FIG. 3 is a schematic view of composite particles contained in the negative electrode active material layer according to the first embodiment.

### DESCRIPTION OF EMBODIMENTS

Hereinafter, the embodiments will be described in detail with reference to the drawings as appropriate. The drawings that are used in the following description may show characteristic portions in an enlarged scale for the sake of convenience in order to facilitate the understanding of the characteristics, and thus the dimensional ratios or the like of the respective components may differ from the actual ones. The materials, dimensions, and the like, which are exemplified in the following description, are merely examples, and the present disclosure is not limited thereto. Therefore, an appropriate modification can be made within the scope that does not deviate from the gist of the present disclosure.

### “Lithium Ion Secondary Battery”

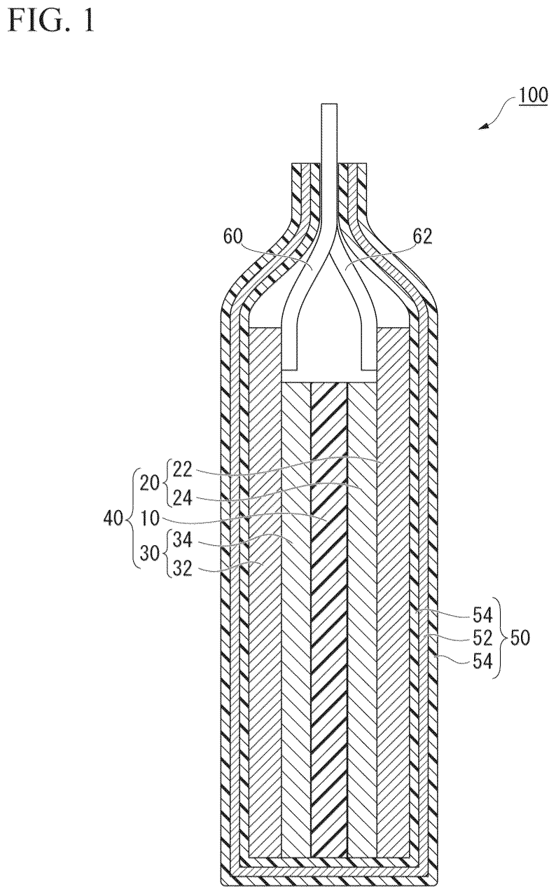

FIG. 1 is a schematic cross-sectional view of a lithium ion secondary battery according to a first embodiment. A lithium ion secondary battery 100 shown in FIG. 1 may include a power generation element 40, an exterior body 50, and an electrolytic solution (for example, a non-aqueous electrolytic solution). The exterior body 50 may cover the periphery of the power generation element 40. The power generation element 40 may be connected to the outside by a pair of terminals 60 and 62 which are connected to the power generation element 40. The non-aqueous electrolytic solution may be accommodated within the exterior body 50. In an implementation, as illustrated in FIG. 1 illustrates, one power generation element 40 may be provided within the exterior body 50, or a plurality of power generation elements 40 may be laminated.

### (Power Generation Element)

The power generation element 40 may include a separator 10, a positive electrode 20, and a negative electrode 30. The power generation element 40 may be a laminate in which these are laminated or may be a wound body in which a structure obtained by laminating these is wound.

### <Positive Electrode>

The positive electrode 20 may have, for example, a positive electrode current collector 22 and a positive electrode active material layer 24. The positive electrode active material layer 24 may be in contact with at least one surface of the positive electrode current collector 22.

### [Positive Electrode Current Collector]

The positive electrode current collector 22 may be, for example, a conductive plate material. The positive electrode current collector 22 may be a thin plate of a metal, for example, aluminum, copper, nickel, titanium, or stainless steel. In an implementation, aluminum, which is lightweight, may be used for the positive electrode current collector 22. The average thickness of the positive electrode current collector 22 may be, for example, 10 μm or more and 30 μm or less.

### [Positive Electrode Active Material Layer]

The positive electrode active material layer 24 may contain, for example, a positive electrode active material. In an implementation, the positive electrode active material layer 24 may contain a conductive auxiliary agent and a binder.

The positive electrode active material layer may contain an electrode active material that enables reversible absorbing and releasing of lithium ions, desorbing and inserting (intercalating) of lithium ions, and doping and dedoping of lithium ions and counter anions.

The positive electrode active material may be, for example, a complex metal oxide. The complex metal oxide may be an oxide that primarily contains, for example, transition metal elements and lithium. The transition metal elements may include, for example, Ti, V, Cr, Mn, Fe, Co, Ni, Mo, or W. In an implementation, the transition metal element may include, e.g., V, Cr, Mn, Fe, Co, or Ni. The molar ratio of lithium in the transition metal elements (lithium/transition metal elements) may be, for example, 0.3 or more and 2.2 or less.

The positive electrode active material may contain Al, Ga, In, Ge, Sn, Pb, Sb, Bi, Si, P, B, or the like in a range of 30% by mole or less with respect to the transition metal elements. In an implementation, the positive electrode active material may be, for example, a material having a spinel structure represented by a general formula Li_{y}MO2 (M is at least one of Co, Ni, or Fe, Mn, O≤y≤1.2) or Li_{z}N₂O₄ (N includes at least Mn, 0≤z≤2).

In an implementation, the positive electrode active material may be, for example, lithium cobaltate (LiCoO₂), lithium nickelate (LiNiO₂), lithium manganate (LiMnO₂), or lithium manganese spinel (LiMn₂O₄), as well as a compound of a general formula: LiNiₓCo_{y}Mn_{z}MₐO₂ (in the general formula, x+y+z+a=1, 0≤x<1, 0≤y<1, 0≤z<1, and 0≤a<1 are satisfied, and M is one or more kinds of elements selected from Al, Mg, Nb, Ti, Cu, Zn, and Cr), a lithium vanadium compound (LiV₂O₅), an olivine-type LiMPO₄ (here, M represents one or more kinds of elements selected from Co, Ni, Mn, Fe, Mg, Nb, Ti, Al, and Zr, or VO), lithium titanate (Li₄Ti₅O₁₂), and LiNiₓCo_{y}Al_{z}O₂ (0.9<x+y+z<1.1). The positive electrode active material may be an organic material. For example, the positive electrode active material may be polyacetylene, polyaniline, polypyrrole, polythiophene, or polyacene.

The positive electrode active material may be a lithium-free material. Examples of the lithium-free material may include FeF₃, a conjugated polymer containing an organic conductive material, a Chevrel phase compound, a transition metal chalcogenide, a vanadium oxide, and a niobium oxide. As the lithium-free material, any one material in description above may be used alone, or a plurality of the materials described above may be used in combination. In a case where the positive electrode active material is a lithium-free material, for example, discharging may be first carried out. Lithium may be inserted into the positive electrode active material by discharging. In addition, the positive electrode active material as a lithium-free material may be pre-doped with lithium chemically or electrochemically.

The conductive auxiliary agent may help enhance electron conductivity between the positive electrode active materials. The conductive auxiliary agent may be, for example, a carbon powder, a carbon nanotube, a carbon material, a fine metal powder, a mixture of a carbon material and a metal fine powder, or a conductive oxide. Examples of the carbon powder may include carbon black, acetylene black, and Ketjen black. The fine metal powder may be, for example, a powder of copper, nickel, stainless steel, or iron.

The binder in the positive electrode active material layer 24 may bind the positive electrode active material. As the binder, a suitable binder can be used. The binder may be one that is insoluble in the electrolytic solution, has oxidation resistance, and has adhesiveness. The binder may be, for example, a fluororesin. Examples of the binder may include polyvinylidene fluoride (PVDF), polyvinyl alcohol (PVA), polytetrafluoroethylene (PTFE), polyamide (PA), polyimide (PI), polyamideimide (PAI), polybenzimidazole (PBI), polyether sulfone (PES), a tetrafluoroethylene-hexafluoropropylene copolymer (FEP), a tetrafluoroethylene-perfluoroalkyl vinyl ether copolymer (PFA), an ethylene-tetrafluoroethylene copolymer (ETFE), polychlorotrifluoroethylene (PCTFE), an ethylene-chlorotrifluoroethylene copolymer (ECTFE), and polyvinyl fluoride (PVF).

In an implementation, the binder may be a fluororubber. The binder may include, for example, a vinylidene fluoride-hexafluoropropylene fluororubber (VDF-HFP fluororubber), a vinylidene fluoride-hexafluoropropylene-tetrafluoroethylene fluororubber (VDF-HFP-TFE fluororubber), a vinylidene fluoride-pentafluoropropylene fluororubber (VDF-PFP fluororubber), a vinylidene fluoride-pentafluoropropylene-tetrafluoroethylene fluororubber (VDF-PFP-TFE fluororubber), a vinylidene fluoride-perfluoromethyl vinyl ether-tetrafluoroethylene fluororubber (VDF-PFMVE-TFE fluororubber), or a vinylidene fluoride-chlorotrifluoroethylene fluororubber (VDF-CTFE fluororubber).

### <Negative Electrode>

The negative electrode 30 may have, for example, a negative electrode current collector 32 and a negative electrode active material layer 34. The negative electrode active material layer 34 may be formed on at least one surface of the negative electrode current collector 32.

### [Negative Electrode Current Collector]

The negative electrode current collector 32 may be, for example, a conductive plate material. As the negative electrode current collector 32, the same one as in the positive electrode current collector 22 can be used.

### [Negative Electrode Active Material Layer]

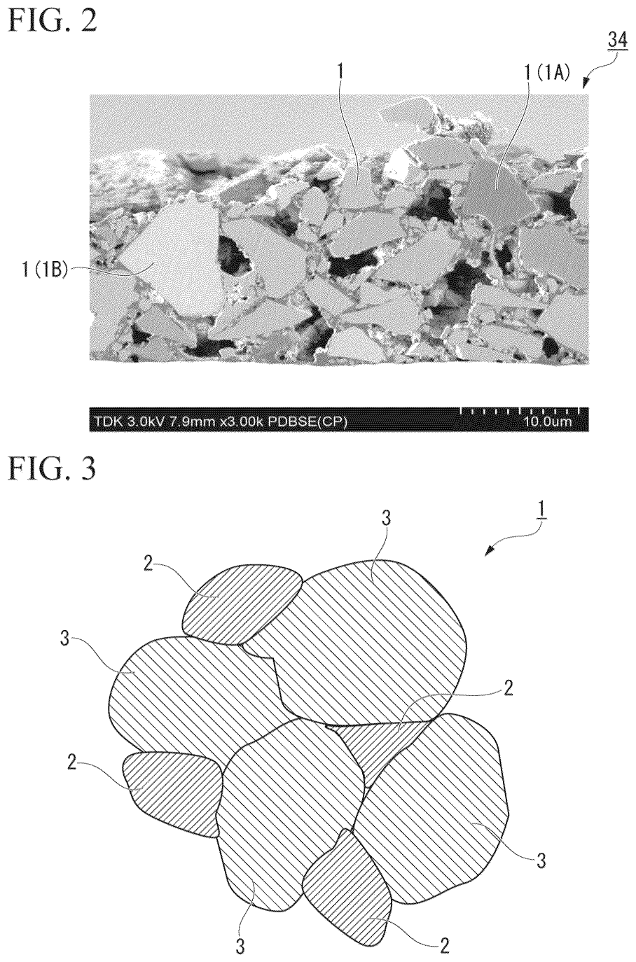

FIG. 2 is an image of a cross section of the negative electrode active material layer 34 according to the first embodiment, which is captured with a scanning electron microscope (SEM). The negative electrode active material layer 34 may contain composite particles 1 in which carbonaceous particles and silicon particles are complexed. In the negative electrode active material layer 34, there may be a plurality of the composite particles 1. The negative electrode active material layer 34 is an example of the negative electrode material. The composite particle 1 may function as the negative electrode active material. The negative electrode active material layer 34 may also contain a binder, a conductive auxiliary agent, or the like, in addition to the composite particles 1.

The composite particle 1 may include a first composite particle 1A and a second composite particle 1B. The first composite particle 1A may have a silicon content of 0.5% by weight or more and 5% by weight or less. A plurality of the first composite particles 1A may be present within the negative electrode active material layer 34. The second composite particle 1B may have a higher silicon content than the first composite particle 1A. The second composite particle 1B may have a silicon content of 60% by weight or more and 70% by weight or less. A plurality of the second composite particles 1B may be present within the negative electrode active material layer 34. The composite particle 1 may have composite particles other than the first composite particle 1A and the second composite particle 1B.

The silicon content of the composite particle 1 can be measured by energy dispersive X-ray spectroscopy (EDS) by irradiating the composite particle 1, which is confirmed in the cross-sectional SEM image, with an electron beam. In addition, the weight ratio of carbonaceous particles in the composite particle 1 can also be measured by an infrared absorption method after combustion in a high-frequency induction furnace, and the weight ratio of silicon particles in the composite particle 1 can also be measured by a inductively coupled plasma (ICP) emission spectrophotometric analysis method.

The average silicon content of the composite particle 1 may be, for example, 40% by weight or more and 60% by weight or less, or 45% by weight or more and 50% by weight or less. The average silicon content of the composite particle 1 may be, for example, the average value from at least 50 composite particles 1.

In the negative electrode active material layer 34, the proportion of the first composite particles 1A may be, for example, 3% by volume or more and 40% by volume or less, or 6% by volume or more and 30% by volume or less. In the negative electrode active material layer 34, the proportion of the second composite particle 1B may be, for example, 1% by volume or more and 20% by volume or less, or 2% by volume or more and 15% by volume or less. For example, in a case where the silicon content of the composite particle 1 contained in the negative electrode active material layer 34 is graphically shown on the horizontal axis, and the number of the composite particles 1 having a silicon content within a predetermined range is graphically shown on the vertical axis, the graph shows two peaks, one of which is in a range in which the silicon content is 0.5% by weight or more and 5% by weight or less, and the other of which is in a range in which the silicon content is 60% by weight or more and 70% by weight or less.

The average secondary particle diameter of the composite particles 1 may be 3 μm or more and 10 μm or less. In a case where the average secondary particle diameter of the composite particles 1 is 3 μm or more, conductivity between composite particles 1 can be ensured even in a case where the amounts of the binder and the conductive auxiliary agent are small. In addition, in a case where the average secondary particle diameter of the composite particles 1 is 10 μm or less, the composite particles 1 are less likely to be damaged during the charging and discharging of the lithium ion secondary battery 100.

The average secondary particle diameter of the composite particle 1 can be determined, for example, from a cross-sectional image of the negative electrode active material layer 34. The cross-sectional image can be measured with a scanning electron microscope (SEM) or a transmission electron microscope (TEM). The average secondary particle diameter of the composite particle 1 can be measured by observing the composite particle 1 by using, for example, a scanning electron microscope JSM-7600 (manufactured by JEOL Ltd.) at a magnification of 100,000 times, and then subjecting the captured image to image processing.

The average secondary particle diameter may be determined, for example, by using the image processing software HALCON (registered trademark, manufactured by MVTec Software GmbH). This software recognizes particles in the captured image, removes particles that are not fully captured at the end portion of the observation field, measures the maximum length (the diameter of the circumscribed circle of the particle) for each particle, and carries out the conversion of the maximum length into the particle diameter. Such a measurement is carried out for 200 particles, a number-based cumulative particle size distribution is determined, and from the number-based cumulative particle size distribution, the average secondary particle diameter of the composite particle 1 is calculated, whereby the average secondary particle diameter can be determined.

The specific surface area of the composite particle 1 may be, for example, 3 m²/g or more and 25 m²/g or less. The specific surface area can be measured, for example, by a BET method (a multimolecular layer adsorption method). In an implementation, it can be determined using a Gemini 2360 (manufactured by Micromeritics Instrument Corp.), by pre-drying a specimen at 200° C. for 20 minutes under nitrogen flow and subsequently allowing nitrogen gas to flow for 5 minutes to carry out the BET 7-point method with the nitrogen gas adsorption.

The specific surface area of the composite particle 1 being sufficiently large indicates that there are many gaps within the composite particle 1. The gaps between composite particles 1 may help alleviate stress concentration caused by the expansion and contraction of silicon particles during charging and discharging, which prevents damage to the composite particles 1. In a case where the specific surface area of the composite particle 1 is not allowed to be too large, it is possible to suppress excessive side reactions between the silicon particles of the composite particle 1 and the electrolytic solution.

FIG. 3 is a schematic view of composite particles contained in the negative electrode material according to the first embodiment. The composite particle 1 may be composed of a carbonaceous particle 2 and the silicon particle 3. Each of the first composite particle 1A and the second composite particle 1B may contain the carbonaceous particle 2 and the silicon particle 3. The first composite particle 1A may have a lower presence ratio of the silicon particles 3 than the second composite particle 1B (e.g., the first composite particle 1A may include fewer silicon particles 3 that the second composite particle 1B).

Both the carbonaceous particle 2 and the silicon particle 3 may be amorphous. Here, the term “amorphous” is intended to indicate a structural body that does not have a regular arrangement of atoms over the long distance in terms of the scale of the interatomic distances, where the amorphous substance is a substance that does not show a clear X-ray diffraction pattern. The phrase “does not show a clear X-ray diffraction image” means, for example, that there is no peak having a half-width of 5° or less in the X-ray diffraction spectrum.

The amorphous carbon particle 2 and the silicon particle 3 may have no anisotropy in the direction of the infiltration of lithium ions during the insertion and desorption of lithium ions and have excellent input-output characteristics. In addition, the amorphous silicon particle may also be less likely to be damaged during volume expansion.

In an implementation, the silicon particle 3 may be a simple body, or it may be a silicon alloy or a silicon oxide. The silicon particle 3 may be crystalline or amorphous.

The silicon alloy may be represented by, for example, XₙSi. X may be a cation. Examples of X may include Ba, Mg, Al, Zn, Sn, Ca, V, Cr, Mn, Fe, Co, Ni, Cu, Zn, Ge, Y, Zr, Nb, Mo, W, Au, Ti, Na, and K. n may satisfy 0≤n≤0.5.

The silicon oxide may be represented by SiOₓ, where x satisfies, for example, 0.8≤x≤2. The silicon oxide may consist of only SiO₂, may consist of only SiO, or may be a mixture of SiO and SiO₂. In addition, the silicon oxide may be such that some oxygen is deficient.

The average primary particle diameter of the silicon particles may be, for example, 1 nm or more and 50 nm or less. The average primary particle diameter of the silicon particles 3 can be determined in the same manner as the average secondary particle diameter of the composite particles 1. The average primary particle diameter of the silicon particles 3 can be measured by observing the cross section of the composite particle 2 by using, for example, a scanning electron microscope JSM-7600 (manufactured by JEOL Ltd.), and then subjecting the captured image to image processing. In this case, the carbonaceous particles 2 are removed through image processing to calculate the average primary particle diameter.

In a case where the average primary particle diameter of the silicon particles 3 is within the above-described range, it is possible to suppress the decomposition of the electrolytic solution, which is one of the side reactions caused by the contact between the silicon particles 3 and the electrolytic solution, and the increase in the film resistance of the film formed in association with the decomposition of the electrolytic solution. In addition, in a case where the average primary particle diameter of the silicon particles 3 is within the above-described range, the silicon particles 3 are less likely to be damaged by expansion and contraction during charging and discharging.

The carbonaceous particle 2 is complexed with the silicon particle 3. Examples of the carbonaceous particle 2 may include a carbide that is generated after baking graphite, graphene, and pitches, and a carbide that is generated after baking resins. The carbonaceous particle 2 may be of two or more kinds.

Examples of the pitches may include coal pitches, petroleum pitches, and synthetic pitches, and examples thereof include coal tar, tar light oil, tar medium oil, tar heavy oil, naphthalene oil, anthracene oil, coal tar pitch, pitch oil, mesophase pitch, oxygen-crosslinked petroleum pitch, heavy oil, coke, low molecular weight heavy oil, and derivatives thereof.

Examples of the resins may include a thermoplastic resin such as polyvinyl alcohol, a phenol resin, an epoxy resin, a melamine resin, a urea resin, an aniline resin, a cyanate resin, a furan resin, a ketone resin, an unsaturated polyester resin, a urethane resin, and modified products thereof. Examples of the phenol resin may include a novolac-type phenol resin and a resole-type phenol resin. Examples of the epoxy resins may include a bisphenol type epoxy resin and a novolac type epoxy resin. Examples of the resins may include polyethylene, polystyrene, an acrylonitrile-styrene (AS) resin, an acrylonitrile-butadiene-styrene (ABS) resin, polypropylene, polyethylene terephthalate, polycarbonate, polyacetal, polyphenylene ether, polybutylene terephthalate, polyphenylene sulfide, polysulfone, polyether sulfone, polyether ether ketone, and polyvinyl chloride.

As the conductive auxiliary agent and the binder, the same one as in the positive electrode 20 can be used. The binder in the negative electrode 30 may be, in addition to those exemplified for the positive electrode 20, for example, cellulose, styrene-butadiene rubber, ethylene-propylene rubber, a polyimide resin, a polyamide-imide resin, or an acrylic resin. The cellulose may be, for example, carboxymethyl cellulose (CMC).

### <Separator>

The separator 10 may be sandwiched between the positive electrode 20 and the negative electrode 30. The separator 10 separates the positive electrode 20 from the negative electrode 30 and may help prevent a short circuit between the positive electrode 20 and the negative electrode 30. The separator 10 may extend in-plane along the positive electrode 20 and the negative electrode 30. Lithium ions can pass through the separator 10.

The separator 10 may have, for example, a porous structure having electrical insulating properties. The separator 10 may be, for example, a single layered body or laminate of a polyolefin film. The separator 10 may be a stretched film of a mixture of polyethylene and polypropylene. The separator 10 may be a fibrous nonwoven fabric including cellulose, polyester, polyacrylonitrile, polyamide, polyethylene, or polypropylene. The separator 10 may be, for example, a solid electrolyte. The solid electrolyte may be, for example, a polymer solid electrolyte, an oxide solid electrolyte, or a sulfide solid electrolyte. The separator 10 may be an inorganic coated separator. The inorganic coated separator may be one that is obtained by coating the surface of the above-described film with a mixture of a resin such as PVDF or CMC and an inorganic substance such as alumina or silica. The inorganic coated separator may have an excellent heat resistance and suppresses the precipitation of transition metals eluted from the positive electrode, onto the surface of the negative electrode.

### <Electrolytic Solution>

The electrolytic solution may be enclosed in the exterior body 50, and the power generation element 40 may be impregnated with the electrolytic solution. The electrolytic solution may be a liquid electrolytic solution or may be a solid electrolytic solution. The non-aqueous electrolytic solution may contain, for example, a non-aqueous solvent and an electrolytic salt. The electrolytic salt may be dissolved in a non-aqueous solvent.

The solvent may be a suitable solvent that is generally used in lithium-ion rechargeable batteries. The solvent may include, for example, any of a cyclic carbonate compound, a chain-like carbonate compound, a cyclic ester compound, or a chain-like ester compound. The solvent may contain these compounds in any mixture ratio. Examples of the cyclic carbonate compound may include ethylene carbonate (EC), propylene carbonate (PC), butylene carbonate, fluoroethylene carbonate, and vinylene carbonate. Examples of the chain-like carbonate compound may include diethyl carbonate (DEC), dimethyl carbonate (DMC), and ethyl methyl carbonate (EMC). An example of the cyclic ester compound may include γ-butyrolactone. Examples of the chain-like ester compound may include propyl propionate, ethyl propionate, and ethyl acetate. The ratio of the chain-like carbonate to the cyclic carbonate in a non-aqueous solvent may be, for example, preferably 1:9 to 1:1 in terms of volume.

The electrolytic salt may be, for example, a lithium salt. Examples of the electrolyte may include LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, and LiN(FSO₂)₂. One kind of lithium salt may be used alone, or two or more thereof may be used in combination. From the viewpoint of the degree of ionization, the electrolyte may contain LiPF₆. The dissociation rate of the electrolytic salt in a carbonate solvent at room temperature may be 10% or more.

In a case of dissolving LiPF₆ in a non-aqueous solvent, the concentration of the electrolyte in the non-aqueous electrolytic solution may be adjusted to be 0.5 mol/L or more and 2.0 mol/L or less. In a case where the concentration of the electrolyte is 0.5 mol/L or more, it is possible to sufficiently ensure the conductivity of the non-aqueous electrolytic solution, which makes it easier to obtain sufficient capacity during charging and discharging. In addition, in a case where the concentration of the electrolyte is suppressed within 2.0 mol/L, the increase in the viscosity of the non-aqueous electrolytic solution can be suppressed, which makes it possible to ensure sufficient mobility of lithium ions and makes it easier to obtain sufficient capacity during charging and discharging.

In an implementation, even in a case of mixing LiPF₆ with other electrolytic solutions, the lithium ion concentration in the non-aqueous electrolytic solution may be adjusted to 0.5 mol/L or more and 2.0 mol/L or less, and the concentration of lithium ions from LiPF₆ may account for 50% by mole or more of the total.

### <Exterior Body>

The exterior body 50 may seal, in the inside thereof, the power generation element 40 and the non-aqueous electrolytic solution. The exterior body 50 may help suppress the leakage of the non-aqueous electrolytic solution to the outside, the infiltration of moisture or the like into the lithium ion secondary battery 100 from the outside.

As shown in FIG. 1, the exterior body 50 may have, for example, a metal foil 52 and a resin layer 54 laminated on each side of the metal foil 52. The exterior body 50 may be a metal laminate film that is obtained by coating the metal foil 52 on both sides with a polymer film (resin layer 54).

As the metal foil 52, for example, an aluminum foil can be used. For the resin layer 54, a polymer film such as polypropylene can be used. The material that constitutes the resin layer 54 may be different between the inner side and the outer side. For example, as a material for the outer side, a polymer having a high melting point, for example, polyethylene terephthalate (PET) or polyamide (PA) can be used, and as a material of the polymer film for the inner side, polyethylene (PE), polypropylene (PP), or the like can be used.

### <Terminal>

The terminals 62 and 60 may be connected to the positive electrode 20 and the negative electrode 30, respectively. The terminal 62 connected to the positive electrode 20 may be a positive electrode terminal, and the terminal 60 connected to the negative electrode 30 may be a negative electrode terminal. The terminals 60 and 62 may be responsible for electrical connection to the outside. The terminals 60 and 62 may be formed from a conductive material such as aluminum, nickel, copper, or the like. The connection method may be welding or screwing. The terminals 60 and 62 may be protected with an insulating tape to prevent short circuits.

### “Manufacturing Method for Lithium Ion Secondary Battery”

The lithium ion secondary battery 100 may be produced by producing the negative electrode 30, the positive electrode 20, the separator 10, the electrolytic solution, and the exterior body 50, and then assembling them. Hereinafter, one example of a manufacturing method for the lithium ion secondary battery 100 will be described.

The negative electrode 30 may be produced, for example, by sequentially carrying out a slurry production step, an electrode application step, a drying step, and a rolling step.

The slurry production step may be a step of mixing the negative electrode active material, the binder, the conductive auxiliary agent, and the solvent to produce a slurry.

First, a manufacturing method for the negative electrode active material will be described. The negative electrode active material may be produced through a composite particle production step, a mixing step, a drying step, and a heat treatment step.

First, in the composite particle production step, silicon particles and a carbon source may be mixed in an organic solvent. The weight ratio of the silicon particles to the carbonaceous particles in the composite particles can be adjusted by the mixing ratio of the silicon particles to the carbon source. For example, the first composite particle 1A having a silicon content of 0.5% by weight or more and 5% by weight or less, and the second composite particle 1B having a silicon content of 60% by weight or more and 70% by weight or less may be separately produced.

For the silicon particles, for example, a silicon ingot may be pulverized in multiple stages to make the average particle diameter 1 nm or more and 50 nm or less. The silicon ingot may be produced, for example, by rapidly cooling molten silicon. By rapidly cooling the molten silicon in which silicon and the like have melted, it is possible to prevent excessive crystallization of silicon particles, thereby allowing the silicon particles to become amorphous. The cooling rate may be, for example, 10³ K/s or more and 10⁸ K/s or less.

The pulverization of the silicon ingot can be carried out using, for example, a ball mill or a media mill. As the ball mill, for example, a planetary mill, a vibrating ball mill, a conical mill, or a tube mill can be used. As the media mill, a media mill such as an attritor type, a sand grinder type, an annular mill type, or a tower mill type can be used. The particle diameter of the silicon particles may be controlled using a sieve.

In an implementation, the silicon particles may be produced by a spraying method. The spray method may be a method of producing fine particles by melting a metal and spraying the molten silicon. The spray method may include a method of carrying out spraying with an inert gas to form a powder (a gas atomization method), a method of carrying out spraying onto a rotating disk to form a powder, a method of carrying out spraying with high-pressure water to form a powder (a water atomization method), a method of pouring a metal sprayed into a rotating water stream that rotates at a high speed (an atomization method), or the like.

In addition, the molten silicon may also be cooled using a gun method, a single roll method, or a twin roll method. By using these methods, the cooling rate of the molten silicon can be increased. The powder or ribbon produced by this method can be further pulverized to adjust the average particle diameter. In addition, the obtained powder may also be subjected to ball milling or the like to further make the silicon particles amorphized.

The carbon source may include graphite, graphene, pitches, resins, or the like. As the pitches and the resins, those described above can be used. The carbon source may include graphite, graphene, a novolac-type phenol resin, a resol-type phenol resin, coal pitch, and petroleum pitch. Two or more kinds of carbon sources may be used.

The organic solvent may include methanol, ethanol, tetrahydrofuran, or the like. A dispersant may be added to the organic solvent. Carbon particles and silicon particles may be uniformly complexed by adding a dispersant. Such composite particles may have excellent electron conductivity and may be less likely to undergo side reactions with the electrolytic solution during charging and discharging.

Next, a mixture obtained by mixing the silicon particles and the carbon source in an organic solvent may be dried. The organic solvent may be removed from the mixture by drying, whereby a powder is obtained. The drying method may include, e.g., a spray drying method.

Next, the powder after the drying may be subjected to a heat treatment. By the heat treatment step, the resin or the resin composition, which serves as a carbon source, may undergo incomplete combustion and may undergo carbonization to become carbonaceous particles. This may allow the silicon particles and carbonaceous particles to be complexed.

The heat treatment may be carried out for the mixture at a heat treatment temperature of 350° C. to 1,200° C. If the heat treatment temperature were to be too low, the carbon source may not sufficiently undergo carbonization, which could cause lithium to be trapped during charging and discharging. In a case where lithium is trapped, the initial efficiency of the lithium ion secondary battery may decrease. If the heat treatment temperature were to be too high, silicon particles and carbonaceous particles may react with each other, and silicon carbide could be excessively generated. Among the silicon compounds, silicon carbide may have a small contribution to charging and discharging and reduces the conductivity of lithium ions, which could cause a decrease in the discharge capacity of the lithium ion secondary battery.

In an implementation, the heat treatment time may be 1 hour or more and 72 hours or less. The heat treatment atmosphere may be a reducing atmosphere such as a nitrogen atmosphere or an argon atmosphere.

Next, a slurry may be produced using the composite particles produced by the above procedure. The slurry can be produced by mixing the first composite particles, the second composite particles, the binder, the conductive auxiliary agent, and the solvent. Examples of the solvent may include water and N-methyl-2-pyrrolidone. The volume ratios of the first composite particle 1A and the second composite particle 1B in the negative electrode active material layer 34 can be adjusted by adjusting the mixing ratio between the first composite particle 1A and the second composite particle 1B in the slurry.

The electrode coating step may be a step of coating the surface of the negative electrode current collector 32 with a slurry. The coating method for the slurry may include a suitable coating method. For example, a slit die coating method or a doctor blade method can be used as the coating method for the slurry. The slurry may be applied, for example, at room or ambient temperature.

The drying step may be a step of removing a solvent from the slurry. For example, the negative electrode current collector 32 coated with slurry may be dried in a temperature environment of 80° C. to 350° C.

In an implementation, the rolling step may be carried out. The rolling step may be a step of applying pressure to the negative electrode active material layer 34 to adjust the density of the negative electrode active material layer 34. The rolling step may be carried out, for example, using a roll press device. The linear pressure of the roll press may be, for example, 100 kgf/cm or more and 2,500 kgf/cm or less.

The positive electrode 20 can be produced according to the same procedure as in the negative electrode 30. As the separator 10 and the exterior body 50, commercially available ones can be used.

Next, the produced positive electrode 20 and negative electrode 30 may be laminated so that the separator 10 is located between them, whereby the power generation element 40 is produced. For example, the positive electrode 20, the separator 10, and the negative electrode 30 may be laminated and pressed to closely adhere them. In a case where the power generation element 40 is a wound body, the positive electrode 20, the negative electrode 30, and the separator 10 may be wound around with one end side thereof as an axis.

Finally, the power generation element 40 may be enclosed in the exterior body 50. The non-aqueous electrolytic solution may be injected into the exterior body 50. After the non-aqueous electrolytic solution is injected, decompression, heating, or the like may be carried out to impregnate the power generation element 40 with the non-aqueous electrolytic solution. Heat or the like may be applied to seal the exterior body 50, whereby the lithium ion secondary battery 100 is obtained. It is noted that instead of injecting the electrolytic solution into the exterior body 50, the power generation element 40 may be immersed in the electrolytic solution. In an implementation, it may be allowed to stand for 24 hours after the injection of liquid into the power generation element.

The lithium ion secondary battery 100 according to the first embodiment may have composite particles having silicon contents that are different from each other. The first composite particle 1A may have a low silicon content, and thus the volume change during the charging and discharging of the lithium ion secondary battery 100 may be small. On the other hand, the first composite particle 1A may contain silicon, and thus it may have the function of an active material. In other words, the first composite particle 1A may function as a cushioning material for the volume change of other composite particles while having a function as an active material. In addition, the second composite particle 1B may have a high silicon content, and thus it may increase the discharge capacity of the negative electrode 30. In an implementation, the composite particles having characteristics different from each other may be present within the negative active material layer 34, and the advantages of the respective composite particle can be obtained. In addition, in a case where the second composite particle 1B has undergone volume expansion, the first composite particle 1A may serve as a cushioning material, thereby being capable of suppressing the damage to the composite particle 1 and being capable of preventing the deterioration of the cycle characteristics of the lithium ion secondary battery 100. In addition, in a case where the composite particle 1 has undergone volume expansion, the composite particles 1 may adhere closely to each other while the first composite particle 1A serves as a cushioning material, which makes smooth the conductive path between the composite particles 1.

As described above, the embodiments of the present disclosure described in detail with reference to the drawings. However, each of the configurations and the combination thereof in each embodiment are examples, and additions, omissions, substitutions, and other modifications of the configuration can be made without departing from the spirit of the present disclosure.

### EXAMPLES

### Example 1

### (Production of Negative Electrode Active Material)

### <Production of First Composite Particle>

Silicon (manufactured by Sigma-Aldrich Co., LLC, purity: 99% or higher) was melted in a vacuum using an arc melting device. Next, the molten silicon was rapidly cooled by spraying it onto a rotating copper roll with argon gas, whereby a silicon powder was produced. Next, silicon powder was pulverized for 24 hours using silicon nitride balls having a diameter of 0.1 mm with a planetary ball mill device in an argon gas atmosphere, whereby silicon particles having an average primary particle diameter of 5 nm were produced.

Next, 5 g of the silicon particles and 200 g of tetrahydrofuran (manufactured by Kanto Chemical Co., Inc., special grade) were added to a 500 ml beaker and stirred with a magnetic stirrer. Subsequently, 6.5 g of a phenol resin (manufactured by DIC Corporation) was added thereto, and stirring was continued for about 0.5 hours. Next, 180 g of a furan resin was added thereto, and stirring was continued for 3 hours. Thereafter, the treatment was carried out for 1 hour using a homogenizer. Using an oven, the obtained mixture was subjected to a heat treatment at 90° C. for about 24 hours and then pulverized to obtain a powder.

Next, 10.00 g of the powder was placed in an alumina crucible, the temperature thereof was raised from room temperature to 900° C. over 5 hours in an argon atmosphere, and a heat treatment was carried out at 900° C. for 4 hours to produce the first composite particles.

### <Production of Second Composite Particle>

The second composite particle was produced in the same manner as the first composite particle. The production method for the second composite particles differed from the production method for the first composite particles in terms of the mixing ratio between the silicon particles, the phenol resin, and the furan resin.

### <Production of Other Composite Particles>

Other composite particles were produced in the same manner as the first composite particle. The production method for other composite particles differed from the production method for the first composite particles in terms of the mixing ratio between the silicon particles, the phenol resin, and the furan resin.

### <Measurement of Carbon Content and Weight Ratio of Silicon Particles>

The weight ratio between the carbonaceous particles and the silicon particles in each of the first composite particle and the second composite particle was determined using an infrared absorption method after combustion in a high-frequency induction furnace and an inductively coupled plasma (ICP) emission spectrophotometric analysis method. First, the weight of the carbonaceous particles contained in the first composite particles and the second composite particles was determined using the infrared absorption method after combustion in a high-frequency induction furnace. Subsequently, the weight of the silicon particles contained in the first composite particles and the second composite particles was measured by the inductively coupled plasma (ICP) emission spectrophotometric analysis method.

### <Measurement of Specific Surface Area of Composite Particles>

The specific surface area of the composite particles was determined using Gemini 2360 (manufactured by Micromeritics Instrument Corp.). The specific surface area was determined by pre-drying a specimen at 200° C. for 20 minutes under nitrogen flow and then allowing nitrogen gas to flow for 5 minutes, and subsequently carrying out the BET 7-point method with the nitrogen gas adsorption.

### [Production of Evaluation Cell]

The first composite particles, the second composite particles, and other composite particles, and a mixture obtained by mixing polyimide (PI), which is a binder, and acetylene black were dispersed in N-methyl-2-pyrrolidone (NMP), which is a solvent, whereby a slurry was prepared. The slurry was prepared so that the weight ratio between the composite particles, acetylene black, and polyimide in the slurry was 80:10:10. In addition, the mixing ratio between the first composite particles and the second composite particles was adjusted so that the volume ratios of the first composite particles and the second composite particles in the negative electrode active material layer reached a predetermined ratio. The slurry was applied onto a copper foil, which is a current collector, drying was carried out, and then rolling was carried out to produce an electrode (negative electrode) in which the negative active material layer in Example 1 was formed.

Next, a separator made of a polyethylene microporous membrane was sandwiched between the produced negative electrode and a counter electrode of the produced negative electrode, whereby a laminate (power generation element) was obtained. This laminate was placed in an aluminum laminate pack, and a solution obtained by mixing an electrolytic solution at a volume ratio of FEC:VC:EMC=1:1:8 and dissolving LiPF₆ in the resultant mixture to a concentration of 1.3 mol/L was injected into this aluminum laminate pack. Then, vacuum sealing was carried out to produce an evaluation cell for Example 1.

Next, the discharge capacity and cycle characteristics of the evaluation cell were determined. The discharge capacity was determined by measuring, in a constant temperature chamber at 25° C., the charging capacity which was obtained in a case where the charging rate was set to 0.1 C (the current value at which discharging ends in 10 hours in a case where constant current discharge is carried out at 25° C.), and subsequently measuring, in a constant temperature chamber at 25° C., the initial discharge capacity which was obtained in a case where the discharge rate was set to 0.1 C.

In addition, the cycle characteristics were additionally determined by repeating 0.5 C charge/1 C discharge for 50 cycles using the battery cell after the initial discharge capacity measurement, according to the above-described procedure of charging and discharging. Charging and discharging were carried out in a constant temperature chamber at 45° C. The initial discharge capacity was set to 100%, and the value of the discharge capacity after 50 cycles was used as the cycle characteristics. The larger the initial discharge capacity and the cycle characteristics, the more preferable it is.

### Examples 2 to 8

In Examples 2 to 8, the mixing ratio between the first composite particles and the second composite particles when producing the slurry for the negative electrode was changed to change the volume ratio of the first composite particles and the volume ratio of the second composite particles in the negative electrode active material layer. In Examples 2 to 8, the same evaluation as in Example 1 was carried out in the same manner as in Example 1.

### Examples 9 and 10

In Examples 9 and 10, the volume ratios of the first composite particles, the second composite particles, and the other composite particles in a case of producing the slurry for the negative electrode were changed to change the volume ratio of the first composite particles and the volume ratio of the second composite particles as well as the average secondary particle diameter of the composite particles in the negative electrode active material layer. In Examples 9 and 10, the same evaluation as in Example 1 was carried out in the same manner as in Example 1.

### Examples 11 to 14

In Examples 11 to 14, the particle diameter of the silicon particles that constitute the composite particles was changed. Examples 11 and 12 differed from Example 5 in the particle diameter of the silicon particles. Examples 13 and 14 differed from Example 6 in the particle diameter of the silicon particles. In Examples 11 to 14, the same evaluation as in Example 1 was carried out in the same manner as in Example 1.

### Examples 15 and 16

Examples 15 and 16 differed from Example 1 in that the average specific surface area of the composite particles was changed. In Examples 15 and 16, the same evaluation as in Example 1 was carried out in the same manner as in Example 1.

### Comparative Examples 1 and 2

In Comparative Examples 1 and 2, the particle diameter of the silicon particles that constitute the composite particles was changed. In addition, the mixing ratio between the first composite particles and the second composite particles in a case of producing the slurry for the negative electrode was changed to also change the volume ratio of the first composite particles, the volume ratio of the second composite particles in the negative electrode active material layer, and the like. In Comparative Examples 1 and 2, the same evaluation as in Example 1 was carried out in the same manner as in Example 1.

### Comparative Examples 3 to 5

In Comparative Examples 3 to 5, either the first composite particle or the second composite particle was not added in a case of producing the slurry for the negative electrode. In Comparative Examples 3 to 5, the same evaluation as in Example 1 was carried out in the same manner as in Example 1.

### Comparative Examples 6 to 8

In Comparative Examples 6 to 8, crystalline particles or a crystalline carbonaceous material were used as either the silicon particles or the carbonaceous material which constitute the composite particles. In Comparative Examples 6 to 8, the same evaluation as in Example 1 was carried out in the same manner as in Example 1.

The evaluation results of Examples 1 to 18 and Comparative Examples 1 to 8 are summarized in Table 1 and Table 2.

TABLE 1

| | | | | Composite particle | | | | | |
|---|---|---|---|---|---|---|---|---|---|
| | | | | Volume | Volume | | | | |
| | Silicon particle | | | ratio of | ratio of | | | | |
| | Average | | | first | second | Average | | Lithium ion | |
| | primary | | | composite | composite | secondary | Specific | secondary battery | |
| | particle | | Carbon | particles | particles | particle | surface | Discharge | Cycle |
| | diameter | | material | (% by | (% by | diameter | area | capacity | characteristics |
| | (nm) | Crystalline | Crystalline | volume) | volume) | (μm) | (m²/g) | (mAh/g) | (%) |
| Experimental | 5 | Amorphous | Amorphous | 6 | 2 | 3.3 | 8.0 | 1,923 | 98% |
| Example | | | | | | | | | |
| 1 | | | | | | | | | |
| Experimental | 5 | Amorphous | Amorphous | 30 | 15 | 10.0 | 16.0 | 1,953 | 96% |
| Example | | | | | | | | | |
| 2 | | | | | | | | | |
| Experimental | 5 | Amorphous | Amorphous | 6 | 15 | 5.2 | 10.7 | 1,868 | 91% |
| Example | | | | | | | | | |
| 3 | | | | | | | | | |
| Experimental | 5 | Amorphous | Amorphous | 30 | 2 | 6.5 | 21.2 | 1,985 | 92% |
| Example | | | | | | | | | |
| 4 | | | | | | | | | |
| Experimental | 5 | Amorphous | Amorphous | 3 | 1 | 3.5 | 19.4 | 1,945 | 87% |
| Example | | | | | | | | | |
| 5 | | | | | | | | | |
| Experimental | 5 | Amorphous | Amorphous | 40 | 20 | 9.4 | 22.4 | 2,012 | 85% |
| Example | | | | | | | | | |
| 6 | | | | | | | | | |
| Experimental | 5 | Amorphous | Amorphous | 3 | 20 | 7.7 | 6.2 | 1,952 | 87% |
| Example | | | | | | | | | |
| 7 | | | | | | | | | |
| Experimental | 5 | Amorphous | Amorphous | 40 | 1 | 8.7 | 18.2 | 1,811 | 86% |
| Example | | | | | | | | | |
| 8 | | | | | | | | | |
| Experimental | 5 | Amorphous | Amorphous | 18 | 9 | 2.3 | 9.3 | 1,915 | 84% |
| Example | | | | | | | | | |
| 9 | | | | | | | | | |
| Experimental | 5 | Amorphous | Amorphous | 15 | 12 | 11.3 | 5.3 | 1,852 | 88% |
| Example | | | | | | | | | |
| 10 | | | | | | | | | |
| Experimental | 1 | Amorphous | Amorphous | 3 | 1 | 7.4 | 3.0 | 1,866 | 94% |
| Example | | | | | | | | | |
| 11 | | | | | | | | | |
| Experimental | 50 | Amorphous | Amorphous | 3 | 1 | 5.3 | 8.4 | 1,951 | 91% |
| Example | | | | | | | | | |
| 12 | | | | | | | | | |
| Experimental | 1 | Amorphous | Amorphous | 40 | 20 | 6.5 | 15.0 | 1,852 | 94% |
| Example | | | | | | | | | |
| 13 | | | | | | | | | |
| Experimental | 50 | Amorphous | Amorphous | 40 | 20 | 5.2 | 25.0 | 1,925 | 93% |
| Example | | | | | | | | | |
| 14 | | | | | | | | | |

TABLE 2

| | | | | Composite particle | | | | | |
|---|---|---|---|---|---|---|---|---|---|
| | | | | Volume | Volume | | | | |
| | Silicon particle | | | ratio of | ratio of | | | | |
| | Average | | | first | second | Average | | Lithium ion | |
| | primary | | | composite | composite | secondary | Specific | secondary battery | |
| | particle | | Carbon | particles | particles | particle | surface | Discharge | Cycle |
| | diameter | | material | (% by | (% by | diameter | area | capacity | characteristics |
| | (nm) | Crystalline | Crystalline | volume) | volume) | (μm) | (m²/g) | (mAh/g) | (%) |
| Experimental | 5 | Amorphous | Amorphous | 6 | 2 | 9.6 | 2.0 | 1,931 | 88% |
| Example | | | | | | | | | |
| 15 | | | | | | | | | |
| Experimental | 5 | Amorphous | Amorphous | 6 | 2 | 4.2 | 27.0 | 1,915 | 86% |
| Example | | | | | | | | | |
| 16 | | | | | | | | | |
| Experimental | 10 | Amorphous | Amorphous | 12 | 10 | 8.3 | 2.0 | 1,951 | 89% |
| Example | | | | | | | | | |
| 17 | | | | | | | | | |
| Experimental | 20 | Amorphous | Amorphous | 23 | 8 | 5.8 | 27.0 | 1,923 | 87% |
| Example | | | | | | | | | |
| 18 | | | | | | | | | |
| Comparative | 0.7 | Amorphous | Amorphous | 18 | 7 | 7.0 | 5.1 | 1,823 | 64% |
| Example | | | | | | | | | |
| 1 | | | | | | | | | |
| Comparative | 55 | Amorphous | Amorphous | 12 | 21 | 4.2 | 3.3 | 1,754 | 62% |
| Example | | | | | | | | | |
| 2 | | | | | | | | | |
| Comparative | 10 | Amorphous | Amorphous | 15 | 0 | 5.1 | 23.2 | 1,634 | 51% |
| Example | | | | | | | | | |
| 3 | | | | | | | | | |
| Comparative | 20 | Amorphous | Amorphous | 0 | 16 | 6.2 | 14.5 | 1,685 | 56% |
| Example | | | | | | | | | |
| 4 | | | | | | | | | |
| Comparative | 30 | Amorphous | Amorphous | 0 | 0 | 4.1 | 5.8 | 1,542 | 41% |
| Example | | | | | | | | | |
| 5 | | | | | | | | | |
| Comparative | 30 | Crystalline | Graphite | 5 | 4 | 6.0 | 5.3 | 1,945 | 38% |
| Example | | | | | | | | | |
| 6 | | | | | | | | | |
| Comparative | 40 | Crystalline | Amorphous | 35 | 18 | 8.2 | 6.7 | 1,924 | 43% |
| Example | | | | | | | | | |
| 7 | | | | | | | | | |
| Comparative | 3 | Amorphous | Graphite | 9 | 5 | 8.8 | 21.5 | 1,963 | 40% |
| Example | | | | | | | | | |
| 8 | | | | | | | | | |

### REFERENCE SIGNS LIST

1 Composite particle
1A First composite particle
1B Second composite particle
2 Carbonaceous material
3 Silicon particle
10 Separator
20 Positive electrode
22 Positive electrode current collector
24 Positive electrode active material layer
30 Negative electrode
32 Negative electrode current collector
34 Negative electrode active material layer
40 Power generation element
50 Exterior body
52 Metal foil
54 Resin layer
60, 62 Terminal
100 Lithium ion secondary battery

1. A negative electrode material for a lithium ion secondary battery, the negative electrode material comprising:
composite particles in which amorphous carbonaceous particles and amorphous silicon particles are complexed,
wherein an average primary particle diameter of the silicon particles is 1 nm or more and 50 nm or less, and
wherein the composite particles include a first composite particle having a silicon content of 0.5% by weight or more and 5% by weight or less, and a second composite particle having a silicon content of 60% by weight or more and 70% by weight or less.

2. The negative electrode material for a lithium ion secondary battery according to claim 1,
wherein a proportion of the first composite particles is 3% by volume or more and 40% by volume or less, and
wherein a proportion of the second composite particles is 1% by volume or more and 20% by volume or less.

3. The negative electrode material for a lithium ion secondary battery according to claim 2,
wherein the proportion of the first composite particles is 6% by volume or more and 30% by volume or less, and
wherein the proportion of the second composite particles is 2% by volume or more and 15% by volume or less.

4. The negative electrode material for a lithium ion secondary battery according to claim 1, wherein an average secondary particle diameter of the composite particles is 3 μm or more and 10 μm or less.

5. The negative electrode material for a lithium ion secondary battery according to claim 1, wherein a specific surface area of the composite particles is 3 m²/g or more and 25 m²/g or less.

6. A negative electrode for a lithium ion secondary battery, comprising the negative electrode material for a lithium ion secondary battery according to claim 1.

7. A lithium ion secondary battery, comprising:
the negative electrode for a lithium ion secondary battery according to claim 6;
a positive electrode; and
an electrolyte.
